(19) United States
(12) Patent Application Publication
(10) Pub. No.: US 2019/0209958 A1
(43) Pub. Date: Jul. 11, 2019

(54) PORTABLE CARBON FILTER SYSTEM FOR HUNTERS AND OTHER APPLICATIONS

(71) Applicants: Adam Klein, Richland Hills, TX (US); Vance Urbanosky, North Richland Hills, TX (US)

(72) Inventors: Adam Klein, Richland Hills, TX (US); Vance Urbanosky, North Richland Hills, TX (US)

(21) Appl. No.: 15/862,911

(22) Filed: Jan. 5, 2018

(51) Int. Cl. B01D 46/00; A01M 31/00

(52) U.S. Cl. CPC B01D 46/0038; B01D 2257/90; A01M 31/00

(57) ABSTRACT

A portable deodorizing filter device and method for deodorizing the body odor of a person positioned in a particular environment such as a hunting environment including providing a portable unit that can be transported to the particular environment, positioning the portable unit relative to the person in the particular environment, activating the portable unit so as to draw air from around the body of the person located in the particular environment into the deodorizing unit and passing such air through the deodorizing material located therewithin to deodorize the body scent of the person as the scent travels downwind. In one embodiment, the portable unit includes first and second wall structures defining a space therebetween for positioning a deodorizing material therewithin and a fan for drawing air into the unit and through the deodorizing material before expelling the deodorized air back into the atmosphere.

### BACKGROUND OF INVENTION

The present invention relates generally to an apparatus and method for removing scent from a human being and, more particularly, to a method and apparatus for removing scent from a human being in a particular environment such as a hunting environment through the use of a portable battery operated deodorizing filter system that can be positioned and operated in the field in the particular environment of the human being so as to draw the air surrounding the human being into the filtering system through the use of a fan and thereafter passing such air through a deodorizing material such as carbon pellets or other carbon or charcoal type filtering material to deodorize the body scent of the human being in that particular environment.

Human scent control in a hunting environment is very important because animals such as deer typically have a very acute sense of smell and are capable of recognizing human scent at great distances. Particularly, in a deer archery hunting environment, the hunter needs to control his/her scent because the hunter needs to get very close to the animal in order to make a kill. Scent control in a hunting environment has become a very big business and there are many products in the marketplace to help hunters control their scent. For example, such scent control products include special soaps which hunters can use to wash with, laundry detergents and sprays which can be applied directly to the hunter's clothing, and special scent blocking clothing which can be worn by the hunter during a hunt, all of which are designed to eliminate or substantially reduce the hunter's scent in the hunting environment. Scent control is even more important in a windy environment as a hunter's scent will be carried downwind from the hunter's location.

Although scent blocking clothing, sprays, laundry detergents and soaps can mask or substantially eliminate a hunter's body odor, such products may, in and of themselves, leave an odor that is different from the environment in which the hunter is hunting and may likewise be detected by deer and other animals. In addition, depending upon the particular hunting environment, hunters may perspire, drink coffee or other liquids, or eat certain types of food in the hunting environment, all of which produce a smell or odor that is different from the smells and odors existing in the particular hunting environment.

The use of an oxidizing gas such as ozone is likewise known for de-scenting the clothing used by hunters. For example, the clothing of hunters can be treated with ozone or the hydroxyl and hydroperoxide ions either at home or in the field by the application of a small amount of ozone or the hydroxyl and hydroperoxide ions to the clothing in order to remove the human scent or any other foreign scent. This method and a portable ozone generator for discharging a stream of ozone which can be transported by a hunter into the field is disclosed in U.S. Pat. Nos. 7,939,015; 8,404,180; 8,557,177; 5,087,428; D687,531; and U.S. Patent Application Publication No. U.S. 2014/0178255. Still other de-scenting systems and methods for detecting de-scented material are disclosed in U.S. Pat. Nos. 8,329,096 and 8,187,533. All of these known scent elimination devices utilize a portable ozone generator to discharge a stream of ozone directly onto the hunter and the equipment and clothing used by a hunter in the field to eliminate human scent and other foreign scents to the field. Although these ozone generator devices help to eliminate human scent, there is concern that breathing in large amounts of ozone can be detrimental to a person's health.

It is therefore desirable to develop a portable de-scenting system for hunters and other users in other environments that do not involve soaps, detergents, sprays or supplying a stream of oxidizing gas such as ozone directly onto the person, the person's clothing and the person's equipment in the field in order to deodorize the person's scent.

### SUMMARY OF INVENTION

The present invention relates to a portable battery operated carbon filter system that can be carried into the field and used in conjunction with, for example, either a tree stand, a ground blind, or other hunting type shelter in a hunting environment in order to deodorize the hunter's body odor and breath in the hunting environment. Although the present method and deodorizing filter device will be described primarily for use in a hunting environment, it is recognized and anticipated that the present method and apparatus can be used in any environment where a person's scent needs to be deodorized.

The present device includes a double-walled container having a fan associated with one end portion thereof and a central cavity configured to house the electronic equipment and battery used for powering and controlling the operation of the fan. In this regard, the present device includes, for example, a 12 volt fan and associated motor mounted in a fan shroud which is associated with one end portion of the container and a battery such as a lithium ion polymer (LiPo) battery, a charger unit, and a DC motor speed control device to turn the fan on and off and to control the fan speed, all housed within the central cavity of the container. A control knob is associated with the fan shroud for activating the DC motor speed controller for turning the fan on and off and for controlling its speed. The battery charger unit is housed within the central cavity adjacent an opposite end portion of the container and includes a charging port receptacle which can be externally accessed for receiving an externally powered charging cable for charging the battery when not in use.

The double-walled container is formed using a screen type material or wall structure having a plurality of openings extending therethrough such that the air surrounding the hunter or other person and his/her equipment can be drawn into the top portion of the present container through the use of the fan and then expelled through the sides of the container. In this regard, carbon pellets or other deodorizing material are positioned within the space formed between the double walls of the container and the deodorizing material filters the air as it passes into the central cavity of the container and exits through the sidewalls of the container. This method and device not only scrubs body odors contained in the air surrounding the hunter or other person, but it also scrubs and deodorizes that person's breath as the surrounding air is pulled into the present device. Carbon filters such as charcoal filters are well-known for their ability to remove scent associated with air that is passed through the filter. The present device does not produce ozone. It merely filters the surrounding air through the use of carbon, charcoal or other deodorizing filters.

Since the present device is portable, a hunter or other user can simply carry the present device to the hunting or other environment and can position the present device adjacent the hunter or other user either in a tree stand, a ground blind, some other shelter, or at a location near the user such that the air surrounding the hunter or other user can be pulled into the present filter system for de-scenting and deodorizing the air that passes therethrough. The present device can be hung or coupled to a tree stand or merely set on the ground adjacent the hunter or other user depending upon the particular environment. The present device is typically positioned upwind of a person's body so that it can deodorize and de-scent all odors traveling downwind from the user.

### BRIEF DESCRIPTION OF THE DRAWINGS

For a better understanding of the present invention, reference may be made to the accompanying drawings.

FIG. 1 is a perspective view of one embodiment of the present carbon filter system constructed in accordance with the teachings of the present invention.

FIG. 2 is a partial perspective view of the filter box container of FIG. 1 with the fan and associated fan shroud and the bottom cover member removed.

FIG. 3 is a perspective view of the fan, fan motor and fan shroud associated with the portable carbon filter system of FIG. 1.

FIG. 4 is a bottom end view of the portable carbon filter system of FIG. 1 with the bottom cover member removed showing the battery and electronics associated therewith.

FIG. 5 is a perspective view of the present portable carbon filter system of FIG. 1 with the fan and fan shroud removed showing an external charging unit positioned for insertion into a charging port associated with the present carbon filter system.

FIG. 6 is a partial perspective view of the filter box container of FIG. 1 with the bottom cover member removed and showing the deodorizing material positioned within the space formed between the interior and exterior wall structures of the filter box container.

### DETAILED DESCRIPTION OF THE INVENTION

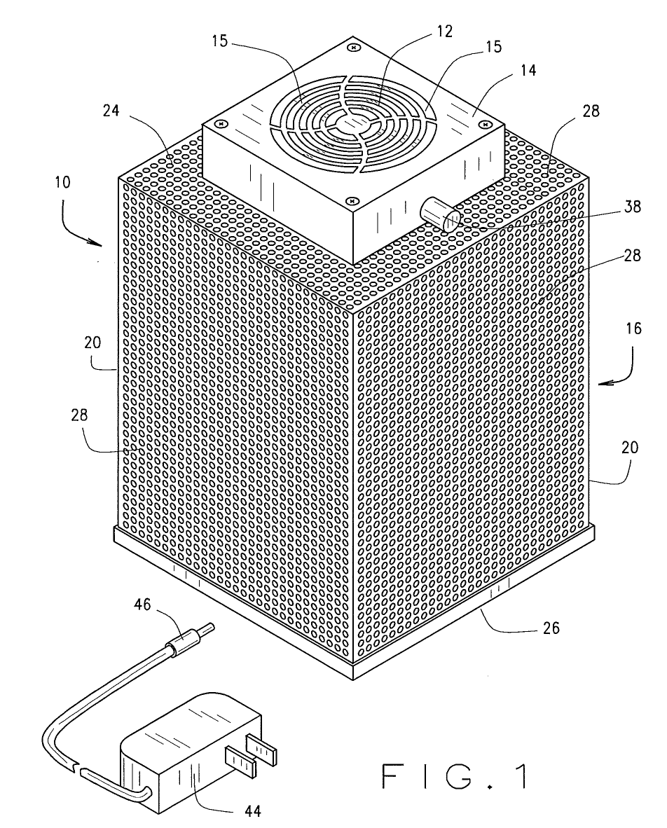

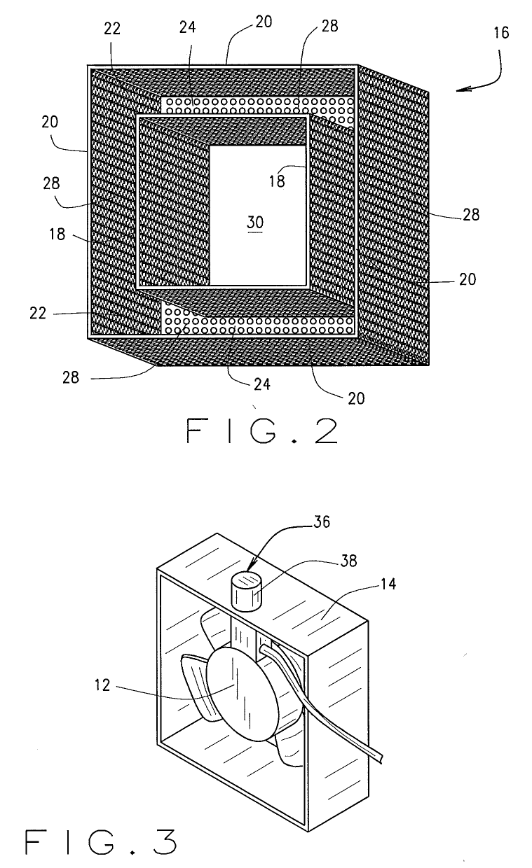

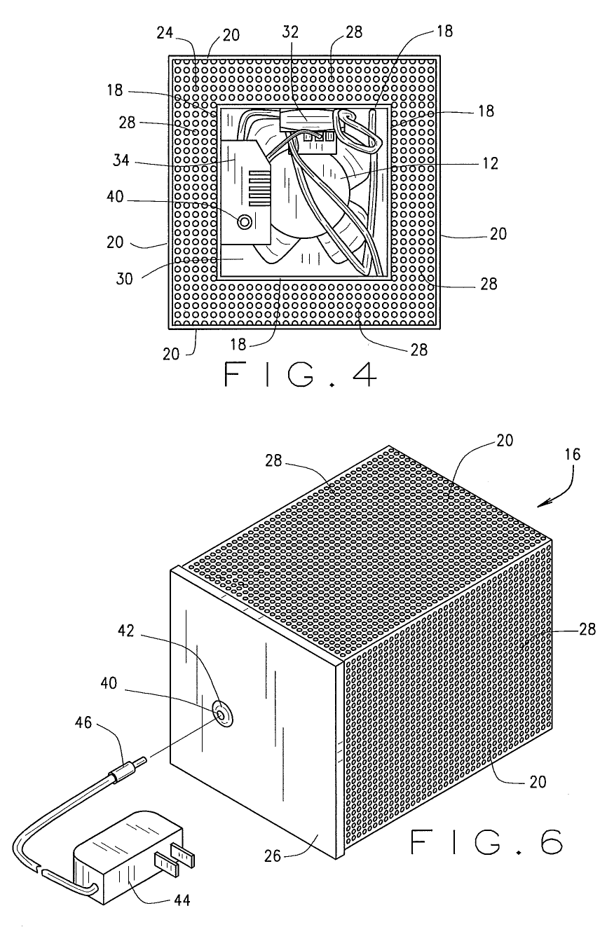

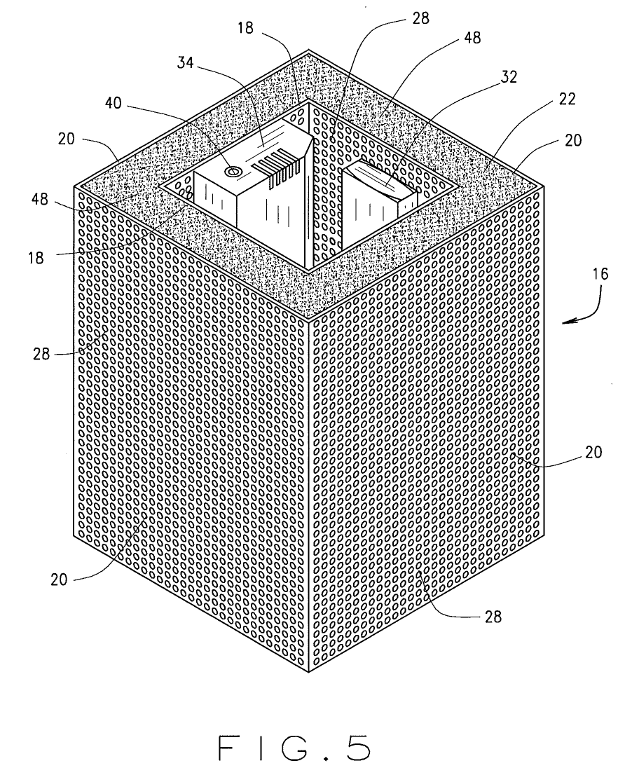

Referring to the drawings more particularly by reference numbers, wherein like numerals refer to like parts, number 10 if FIG. 1 identifies a portable carbon filter system constructed according to the teachings of the present invention. The present device 10 includes a fan and associated motor 12 as best identified in FIG. 3 housed within a fan shroud 14 which is positioned and located adjacent one end portion of a filter box or filter container 16. The fan shroud 14 includes a plurality of slits or openings 15 for drawing air into the unit 10 as will be hereinafter explained. The filter box 16 includes a double walled container as best illustrated in FIG. 2 including an interior first wall structure 18, a spaced apart exterior second wall structure 20 defining a space or channel volume 22 therebetween, a top portion 24 and a bottom cover member 26. Both the interior and exterior wall structures 18 and 20 as well as the top portion 24 are formed of a screen or mesh type material having a plurality of openings 28 associated therewith so that air can easily flow through the respective wall structures. The openings associated with the exterior wall structure 20 on the top portion 24 serves as exit ports for allowing the air that passes therethrough to exit to the atmosphere as will be hereinafter further explained. The internal wall structure 18 includes an interior central space or cavity 30 configured to house the electronic equipment and battery necessary for powering and controlling the operation of the fan 12. In one embodiment, as best illustrated in FIG. 4, the electronics associated with the present device 10 includes a battery 32, a battery charging unit 34, a DC motor speed controller 36 (FIG. 3), and associated wiring. The DC motor speed controller 36 includes a speed control knob 38 for turning the fan motor on and off and for controlling the fan speed as best illustrated in FIG. 3. The battery 32 can be any type of battery capable of operating the fan motor such as a LiPo battery. In one embodiment, the fan motor can be a 12 volt DC fan motor and the battery charging unit 34 can be a balanced charger transformer. The electronic equipment and wiring is housed within the central cavity 30 formed by the inner wall structure 18 and is attached to the opposite end portion of the filter box 16, opposite the fan 12 and adjacent the bottom cover member 26 in a conventional manner. In this regard, the charging unit 34 is positioned and located adjacent the opposite end portion of the filter box or container 16 such that the charging port or receptacle 40 (FIGS. 4 and 6) can be accessed through the bottom cover member 26 as best illustrated in FIG. 6. In this regard, cover member 26 is attached to one end portion of the filter box 16 in a conventional manner such that the charging port 40 is accessible through an opening in cover member 26. A rubber grommet 42 covers the charging port 40. A conventional external charging unit 44 as best shown in FIGS. 1 and 6 can be used to charge battery 32 by plugging the charging unit into a conventional AC wall outlet and inserting the connecting member 46 into the charging port 40.

Carbon is well known for removing smells and contaminates from air and water. Carbon filters such as charcoal filters are known for their ability to remove scent and unwanted odors from a wide variety of different substances before they are released into the atmosphere. For example, carbon filter masks made out of activated carbon filter material are used by crime scene investigators to reduce the scent of decaying bodies. Various plant growers likewise use carbon related filters in their greenhouses to control and scrub greenhouse emissions. Commercial applications also include various types of carbon filters to control industry emissions to the atmosphere. FIG. 5 is an end perspective view of the present filter box container 16 with the bottom cover member 26 removed showing the electronic equipment housed within the internal central cavity 30 and a plurality of carbon pellets 48 positioned within the space or channel volume 22 between the interior and exterior wall structures 18 and 20. Once the carbon pellets, carbon or charcoal activated material, or other deodorizing material is housed within the space 22, the cover plate 26 is attached to the filter box container 16 and the present apparatus is ready for use. The entire closed unit 10 is again illustrated in FIG. 1.

Air travel through the present unit 10 is as follows. When the fan 12 is activated, atmospheric air will be pulled into the present unit 10 through the slits or openings 15 associated with the fan shroud 14. Air entering the fan shroud will travel into the central cavity 30 and through the openings 28 associated with the internal wall structure 18. This air will then travel through the deodorizing material 48 and then exit the filter box container 16 through the openings or exit ports 28 associated with the exterior wall structure 20 and/or the top portion 24 of the container 16.

Because of its size and portability, the present portable deodorizing filter device 10 can be easily carried and transported to any environment for use. For example, in the hunting environment, a hunter can carry the unit 10 to the hunting location such as a tree stand, ground blind, or other hunting shelter and can position the present unit 10 downwind from where the hunter is sitting or otherwise located. The hunter can then turn speed control knob 38 to activate the fan 12 and can control the speed of the fan by rotating the knob 38 between its off position and its high speed position. Positioning the control knob at any intermediate location between off and its high speed position will adjust the fan speed accordingly. The fan speed can be appropriately positioned depending upon the conditions associated with the environment in which the present device 10 is being used such as wind speed, weather conditions, and the denseness of the environment in which the hunter or other user is located such as tree or shrub density, ground cover, crops and so forth. Depending upon the environment and other conditions as mentioned above, the present unit 10 can be placed relative to the hunter, in the vicinity of the hunter, or in close proximity to the hunter. Once the unit 10 is activated and properly set, all air surrounding the hunter or other user including that person's breath will be drawn into the present unit through the use of fan 12 and such air will circulate through the deodorizing material 48 and will then exit the unit into the atmosphere. Once the air is passed through the carbon pellets 48, such air will be deodorized of human scent.

Although the present filter box structure 16 is disclosed as being rectangular or square in shape, it is recognized and anticipated that the container structure 16 can take on any shape including cylindrical, hexagonal or any other trapezoidal shape so long as the container structure includes a structure for holding the carbon pellets or other deodorizing material. Although a double walled structure is preferred, other wall structures are also envisioned. It is also recognized and anticipated that the electronics associated with the present unit 10 can likewise be positioned in other locations associated with the overall container 16 such as adjacent one or both end portions of the unit separated from the carbon pellets or other deodorizing material. For example, the fan shroud 14 can be expanded to include all or some of the electronics and/or the bottom cover member 26 could likewise be expanded to house all or some of the associated electronic equipment. Still further, it is recognized and anticipated that other battery configurations and other chargers, transformers and motor speed control mechanisms can likewise be used as compared to the specific components referenced in the embodiment of the present invention disclosed herein.

It is also recognized and anticipated that the present deodorizing system can be used in many different applications other than a hunting environment for removing and scrubbing a wide variety of different substances other than the human body before such substances are released into the atmosphere. It is also recognized and anticipated that the present unit 10 can be configured both shape and size-wise to accommodate any particular environment. It is also recognized and anticipated that any type of deodorizing material other than carbon pellets can likewise be used within the present unit 10 so long as the unit does not produce ozone. Other variations and modifications to the various components comprising the present unit 10 are also contemplated.

As is evident of the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present device will, however, become apparent to those skilled in the art after considering the specification and accompanying drawings. All such changes, modifications, variations and other uses and applications which do not depart from the spirit and scope of the present invention are deemed to be covered by the invention which is limited only by the claims which follow.

What is claimed is:

1. A portable deodorizing filter device comprising:
a container member having a top portion, a bottom portion, an interior wall structure, an exterior wall structure, and a space defined between the interior and exterior wall structures;
the top portion and the interior and exterior wall structures of the container member including a plurality of openings for allowing air to pass therethrough;
a fan attached to the top portion of the container member for drawing air into the container member;
a deodorizing material positioned within the space defined between the interior and exterior wall structures of the container member for deodorizing air passing therethrough;
a battery for powering the fan; and
electronics for controlling the operation of the fan.

2. A portable deodorizing filter device defined in claim 1 including a central cavity located within the interior wall structure of the container member for housing at least some of the electronics for controlling the operation of the fan.

3. The portable deodorizing filter device defined in claim 1 wherein the electronics includes a speed controller for selectively controlling the speed of the fan.

4. The portable deodorizing filter device defined in claim 1 wherein the electronics includes a battery charging unit for externally charging the battery when not in use.

5. The portable deodorizing filter device defined in claim 4 including a battery charging port associated with the container member.

6. The portable deodorizing filter device defined in claim 1 wherein the deodorizing material is an activated carbon material.

7. The portable deodorizing filter device defined in claim 1 wherein the deodorizing material is an activated charcoal material.

8. The portable deodorizing filter device defined in claim 1 wherein the top portion and the interior and exterior wall structures of the container member are made of a screen type material.

9. A portable carbon filter device comprising:
a container member having a top portion, a bottom portion, an interior wall structure, an exterior wall structure, and a space defined between the interior and exterior wall structures;
the top portion and the interior and exterior wall structures of the container member including a plurality of openings for allowing air to pass therethrough;
a fan housed within a fan shroud, the fan shroud being attached to the top portion of the container member for drawing air into the container member;
a central cavity located within the interior wall structure of the container member;
carbon pellets positioned within the space defined between the interior and exterior wall structures for deodorizing passing therethrough; and
a battery and associated electronics positioned within the central cavity of the container member for powering and controlling the operation of the fan.

10. The portable carbon filter device defined in claim 9 wherein the associated electronics includes a speed control for selectively controlling the speed of the fan.

11. The portable carbon filter device defined in claim 9 wherein the associated electronics includes a battery charging unit for externally charging the battery when not in use.

12. The portable carbon filter device defined in claim 11 including a battery charging port associated with the bottom portion of the container member.

13. A method for deodorizing the body odor of a hunter or other person in a hunting or other environment comprising:
providing a portable deodorizing filter unit that has been transported to the hunting or other environment, the portable deodorizing filter unit including a deodorizing material, a fan for drawing air from around the body of the hunter or other person into the deodorizing filter unit, and exit ports for expelling the deodorized air back into the atmosphere;
positioning the portable deodorizing filter unit relative to the hunter or other person in the hunting or other environment;
activating the fan associated with the portable deodorizing filter unit so as to draw air from around the body of the hunter or other person into the deodorizing filter unit, through the deodorizing material located therewithin, and out of the deodorizing filter unit through the exit ports to deodorize the body scent of the hunter or other person as it travels downwind from the hunter or other person.

14. The method defined in claim 13 wherein the deodorizing material is a carbon material.

15. The method defined in claim 13 wherein the deodorizing material is a charcoal material.

16. The method defined in claim 13 wherein the portable deodorizing filter unit is positioned downwind of the hunter or other person.

17. The method defined in claim 13 wherein the portable deodorizing filter unit is positioned in close proximity to the hunter or other person.

18. The method defined in claim 13 wherein activating the fan associated with the portable deodorizing filter unit also deodorizes the breath of the hunter or other person as it travels downwind from the hunter or other person.

19. The method defined in claim 13 wherein the portable deodorizing filter unit includes first and second spaced apart wall structures defining a space therebetween, said deodorizing material being positioned within said space.

20. A method for removing scent from the body of a person in a particular environment comprising:
providing a portable carbon filter unit that has been transported to the particular environment, the portable carbon filter unit including first and second spaced apart wall structures defining a space therebetween, a carbon activated material positioned within the space between the first and second wall structures, a fan for drawing air from around the body of the person located in the particular environment into the carbon filter unit, and exit ports for expelling the deodorized air back into the atmosphere;
positioning the portable carbon filter unit in the vicinity of the person located in the particular environment; and
activating the fan associated with the portable carbon filter unit so as to draw air carrying the scent of the person in the particular environment into the carbon filter unit, through the carbon pellets located therein, and out of the unit through the exit ports to remove the scent from the body of the person in the particular environment as the scent travels downwind from the particular person.

21. The method defined in claim 20 wherein the portable carbon filter unit is positioned in close proximity downwind of the hunter.
